(19) United States
(12) Patent Application Publication
(10) Pub. No.: US 2026/0042195 A1
(43) Pub. Date: Feb. 12, 2026

(54) STAPLER ALIGNMENT SYSTEMS, APPARATUSES, AND METHODS

(71) Applicant: Race Noeldner, New Franken, WI (US)

(72) Inventor: Race Noeldner, New Franken, WI (US)

(21) Appl. No.: 19/293,691

(22) Filed: Aug. 7, 2025

Related U.S. Application Data
(60) Provisional application No. 63/680,752, filed on Aug. 8, 2024.

(51) Int. Cl. B25C 5/02; B25C 7/00

(52) U.S. Cl. CPC B25C 5/025; B25C 7/00

(57) ABSTRACT

A staple alignment system includes a stapler configured to staple material together and an alignment apparatus including a base configured to axially support the material thereon and a first wall and a second wall axially extending from the base. The first wall and the second wall are configured to guide the material toward the stapler.

### CROSS-REFERENCE TO RELATED APPLICATION

The present disclosure is based on and claims priority to U.S. Provisional Patent Application No. 63/680,752 filed Aug. 8, 2025, the disclosure of which is incorporated herein by reference.

### FIELD

The present disclosure relates to staplers for fastening materials together

### BACKGROUND

Conventional staplers are used in home and office settings for securing materials, such as a stack of papers, to each other. The conventional staplers mechanically force a staple, formed with a malleable material such as metal, into and/or through the materials to thereby bind the materials together. The conventional stapler can also bend the staple such that the staple is not easily removed from the materials.

### SUMMARY

This Summary is provided to introduce a selection of concepts that are further described below in the Detailed Description. This Summary is not intended to identify key or essential features of the claimed subject matter, nor is it intended to be used as an aid in limiting the scope of the claimed subject matter.

In certain examples, a staple alignment system includes a stapler configured to staple material together and an alignment apparatus including a base configured to axially support the material thereon and a first wall and a second wall axially extending from the base. The first wall and the second wall are configured to guide the material toward the stapler.

In certain examples, an alignment apparatus for coupling to a stapler that is configured to staple material together includes a base configured to axially support the material thereon and a first wall and a second wall coupled to and axially extending above the base. The first wall and the second wall are configured to guide the material toward the stapler as the material is received by the alignment apparatus.

In certain examples, staple alignment system includes a stapler configured to staple material together and an alignment apparatus that includes a base configured to axially support the material thereon, the base at least partially defines a slot in which the stapler is received, a first wall and a second wall axially extending from the base, the first wall and the second wall configured to guide the material toward the stapler, and a coupling device coupled to the base and extending into the slot, the coupling device couples to the stapler when the stapler is received into the slot to thereby retain the stapler in the slot.

In certain examples, an alignment apparatus for coupling to a stapler that is configured to staple material together includes a base configured to axially support the material thereon, the base at least partially defines a slot configured to receive the stapler, a first wall and a second wall axially extending from the base, the first wall and the second wall configured to guide the material toward the slot, and a coupling device coupled to the base and extending into the slot, the coupling device configured to couple to the stapler when the stapler is received into the slot to thereby retain the stapler in the slot.

In certain examples, an alignment apparatus for coupling to a stapler that is configured to staple material together includes a base configured to axially support the material thereon, the base includes a first base surface on which the material is supported, at least one slot surface which at least partially defines a slot, and a pair of legs that extend parallel to each other and along the slot, the at least one slot surface extends transverse to the first base surface, a first wall and a second wall axially extending from the base, the first wall and the second wall configured to guide the material toward the slot, the first wall and the second wall are spaced apart from each other and define a void therebetween configured to receive the stapler, and a coupling device coupled to the at least one slot surface and extending into the slot, the coupling device configured to couple to the stapler when the stapler is received into the slot to thereby retain the stapler in the slot.

Various other features, objects, and advantages will be made apparent from the following description taken together with the drawings.

### BRIEF DESCRIPTION OF THE DRAWINGS

The present disclosure is described with reference to the following Figures. The same numbers are used throughout the Figures to reference like features and like components.

FIG. 1 is a perspective view of an example staple alignment system according to the present disclosure.

FIG. 2 is another perspective view of the staple alignment system of FIG. 1.

FIG. 3 is a perspective view of an alignment apparatus of the staple alignment system FIG. 1.

FIG. 4 is another perspective view of the alignment apparatus of FIG. 3.

FIG. 5 is a schematic top-down plan view of the alignment apparatus of FIG. 3 with paper thereon

FIG. 6 is a perspective view of another example alignment apparatus of an example staple alignment system according to the present disclosure.

FIG. 7 is a perspective view of another example staple alignment system according to the present disclosure.

FIG. 8 is a perspective view of another example alignment apparatus of an example staple alignment system according to the present disclosure.

FIGS. 9A-9D are schematic views of other example staple alignment systems according to the present disclosure.

### DETAILED DESCRIPTION

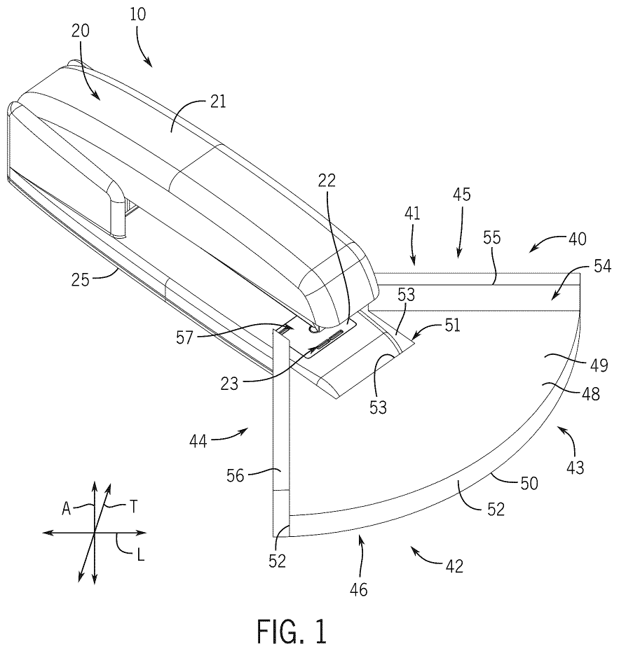

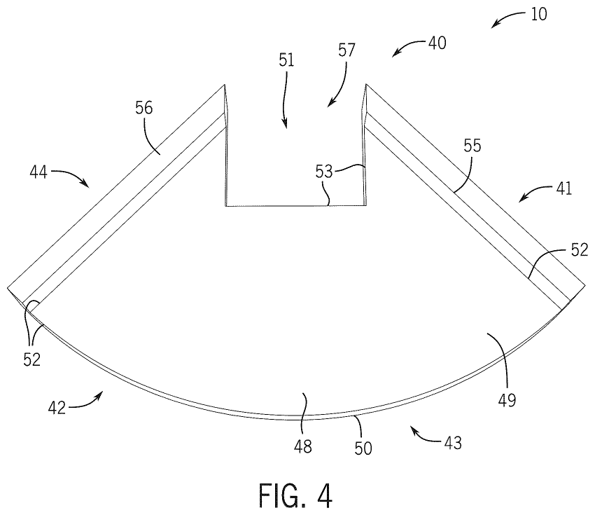

FIGS. 1-4 depict an example staple alignment system 10 according to the present disclosure. The system 10 includes a stapler 20 and an alignment apparatus 40 removably coupled to the stapler 20. The alignment apparatus 40 is for guiding one or more sheets of material, such as paper sheets, into a predetermined alignment position relative to the stapler 20. As such, the stapler 20 applies force to the material and/or a staple is inserted into or formed in the material (e.g., ‘staple-less’ indentation formed in the material, metal staple placed into the material) at the predetermined alignment position in the material. Note that while the example staple alignment systems 10 described below refer to paper or stacks of paper, the example staple alignment systems 10 can be utilized with other materials such as canvas, leather, paper, fabrics, textiles, and the like.

Through research and experimentation, the present inventor recognized that when using conventional staplers to staple materials together it is often difficult to see where the staple or ‘staple-less’ indentation will be applied to the material. These problems may be alleviated by moving the operator's eyes closer to the conventional stapler which may be difficult for some operators. Other operators may lift the conventional stapler off the support surface to get a closer look at the location of the staple will be applied. However, when lifting the conventional stapler off the support surface it is often hard to maintain the staple location in the desired location and may result in inconsistent staple placement which may be exacerbated when stapling multiple sheets of materials. Furthermore, picking up and putting down the conventional stapler is time-consuming and inefficient use of time.

As such, the present inventor developed the example staple alignment systems and components thereof of the present disclosure that enable the operator to consistently locate staples or ‘staple-less’ indentations in the materials without the operator needing to move their eyes closer to the staple location and/or lifting the example staple alignment systems off the support surface. As such, the location of the staples or ‘staple-less’ indentations are more consistent in comparison to when conventional staplers are used to couple material and the materials have a more uniform look once stapled.

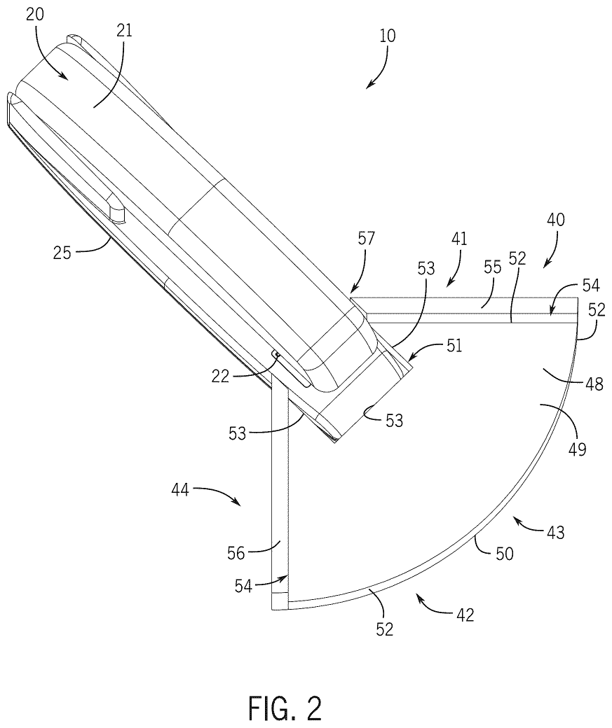

The example stapler 20 (see FIGS. 1-2) includes a handle 21 which is operated by the operator to drive a hammer (not depicted) into an individual staple located in a magazine of the stapler 20. The hammer forces the staple out of the magazine and into material located between the magazine and a crimp plate 22 coupled to a stapler base 25. The handle 21 pivots relative to the stapler base 25, and the staple engages the crimp plate 22 which causes the staple to be crimped. The crimp plate 22 includes one or more sets of depressions 23 in which the ends of the staple are received and directed such that the staple has the desired crimped shape (e.g., a first set of depressions 23 causes the ends of the staple to bend or crimp inwardly towards each other while a second set of depressions 23 causes the ends of the staple to bend or crimp outwardly from each other). Note that in other examples, the stapler 20 is a staple-less stapler or paper clinch. The type of stapler 20 can vary, and in some examples, the stapler 20 is an electric stapler, a heavy-duty stapler, a mini stapler, and/or a handheld stapler.

The alignment apparatus 40 generally longitudinally extends between a first end 41 and a second end 42 (see example longitudinal axis L), laterally extends between a first side 43 and a second side 44 (see example lateral axis T), and axially between a top 45 and a bottom 46 (see example axis A). The alignment apparatus 40 has a base 48 with a first base surface 49 that is configured to face the paper and an opposite second base surface 50 that faces and/or engages a support surface (such as a deck or tabletop). The base 48 is configured to support the paper thereon, and the operator can slide the paper along the first base surface 49. The base 48 has a perimeter 54 that encircles the base 48. The shape of the base 48 can vary, and in the example depicted in FIGS. 1-4, the base 48 has a quarter-circle or quadrant shape. In other examples, the shape of the base 48 can be square or rectangular. In another example, the base 48 has a shape that resembles a fox face.

The base 48 defines a slot 51 that extends inwardly from a perimeter surface 52 that extends around the base 48. The slot 51 is configured to receive the stapler 20. The size and/or shape of the slot 51 can vary, and in certain examples, the shape and size of the slot 51 corresponds to the shape and size of the stapler base 25. The slot 51 is at least partially defined by one or more slot surfaces 53, and the slot surfaces 53 can extend between the first base surface 49 and the second base surface 50. In certain examples, the slot surface 53 extends transverse to the first base surface 49 and the second base surface 50 (e.g., 45.0 degree angle, 90.0 degree angle, 30.0 degree angle).

In certain examples, a coupling device (not depicted) is located along, at, or near the slot surfaces 53 for facilitating coupling between the stapler base 25 and the base 48 and preventing inadvertent movement of the stapler 20 relative to the alignment apparatus 40. In certain examples, the coupling device is coupled to one of the slot surfaces 53 and extends into the slot 51. In one example, the coupling device is an elastic and/or compressible material (e.g., rubber, foam) that engages the stapler base 25. In another example, the coupling device is an adhesive pad. In another example, the coupling device includes one or more magnets that magnetically couple to the metal component of the stapler and/or the alignment apparatus 40. In other examples, the coupling device can be a rubber gripping members (e.g., rubber pads), compressible foam gripping member (e.g., foam strips), and/or elastically deformable plastic prongs that elastically deform when the alignment apparatus 40 is coupled to the stapler 20.

In another example, the two opposing slot surfaces 53 taper inwardly in a direction from the perimeter 54 toward the center of the base 48 such when the stapler 20 is inserted into the slot 51 the slot surfaces 53 compress stapler 20.

Note that in some examples, the alignment apparatus 40 can be permanently coupled to the stapler 20 and/or integrally formed with the stapler 20 when the stapler 20 is manufactured.

A first wall 55 and a second wall 56 are coupled to the perimeter 54 and one or more perimeter surfaces 52 of the base. In other examples, the walls 55, 56 are integrally formed with the base 48. The first wall 55 is located along the first end 41 and the second wall 56 is located along the second side 44. The walls 55, 56 extend axially above from the base The walls 55, 56 are spaced apart from each other such that a void 57 is between the walls 55, 56 and adjacent to the slot 51. The handle 21 of the stapler 20 can extend into the void 57.

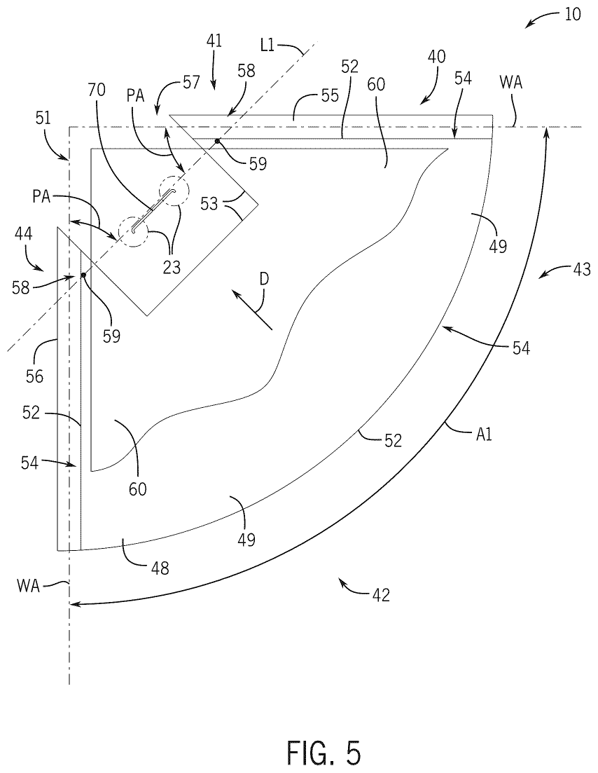

The walls 55, 56 are orientated and/or extend perpendicular to each other such that the walls 55, 56 form a 90.0 degrees therebetween (see angle A1 on FIG. 5). The walls 55, 56 axially extend above the first base surface 49.

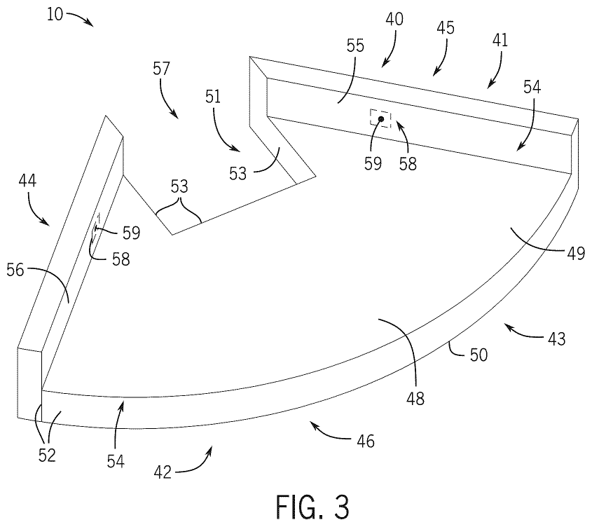

In certain examples, the alignment apparatus 40 includes a marker 58 (see FIGS. 3 and 5) and the marker 58 acts as a visual cue for the operator of the staple alignment system 10 to indicate the position in which the stapler 20 will staple the material. The marker 58 can be removably coupled such that the marker 58 can be moved to different positions on the alignment apparatus 40. The marker 58 can be any suitable device such as an adhesive sticker, a screw, a hook-and-loop pad that couples to a corresponding hook-and-loop pad on the base 48 or the wall 55, 56, and the like. In certain examples, the marker 58 is received in a cannel or track (not depicted) such that the marker 58 can be slid along the track into different positions such that the operator can customize the alignment apparatus 40 for a desired angle and/or position of the staple 70 in the paper and/or the permit a single alignment apparatus 40 to be utilized with a variety of staplers.

FIGS. 3 and 5 schematically depict the marker 58 in dashed lines, and the marker 58 includes an indicia 59 such as a groove, printed letter, number, symbol). The markers 58 can be located on the wall 55, 56 and/or the base 48.

An example operation of the system 10 is described herein below with reference to FIGS. 1-5. Note that FIG. 5 is a top-down schematic view of an example stack of paper 60 on the alignment apparatus 40 without depicting the stapler 20. In operation, the operator first couples the alignment apparatus 40 to the stapler 20 by sliding the stapler base 25 into the slot 51 of the base 48. Optionally, the operator moves the markers 58 on the walls 55, 56 into alignment with depressions 23 in the crimp plate 22. The depressions 23 generally correspond with the location in which the stapler 20 will staple the materials together, and with the markers 58 aligned with depressions 23, line L1 extends between the markers 58 and along the depressions 23. When the paper covers the depressions 23, the markers 58 and the line L1 extending therebetween provide visual cues to the operator so that operator knows the approximate location in which the stapler will staple the materials. The markers 58 can further act as visual cues for properly positioning the stapler base 25 in the void 57.

Note that the markers 58 can be moved based on the based on the size and/or shape of the stapler 20 and the location in which the stapler 20 will staple the paper. For example, markers 58 are moved when a new stapler or new crimp plate is utilized with the system 10. In certain examples, a first alignment apparatus 40 will have markers 58 that correspond with the first stapler 20 while a second alignment apparatus 40 with markers 58 located at different location along the walls 55, 56 relative to the location of the markers 58 on the first alignment apparatus 40 such that the second alignment apparatus 40 is utilized with different staplers 20.

With the stapler 20 coupled to the alignment apparatus 40, the operator slides the paper 60 along the first base surface 49 such that the corner of the paper 60 extends through the void 57 and between the stapler base 25 and the handle 21 (see direction arrow D). The sides of the paper 60 are guided by the walls 55, 56 toward the stapler 20 and into a predetermined position in which the stapler 20 will staple the materials in a desired location. Note that the sides of the paper 60 are depicted spaced apart from the walls 55, 56 on FIG. 5 for clarity. Once the paper 60 is fully inserted into the alignment apparatus 40, the operator can then operate the stapler 20 to apply a staple (schematically depicted as staple 70 on FIG. 5) to the paper 60 in a predetermined location. The paper 60 with the staple coupled thereto can then be removed from the alignment apparatus 40, and the operator can insert another stack of papers 60 into the alignment apparatus 40.

In certain examples, the line L1 and the wall axes WA forms a pair of angles PA therebetween. The angles PA can be equal to each other (e.g., each angle PA is 45.0 degrees). In other examples, the location of one of the markers 58 is changed such that the location of the line L1 and the angles PA are different (e.g., move the marker 58 on the first wall 55 toward the first side 43 such that the angles PA are 15.0 degrees and 30.0 degrees).

In certain examples, the slot 51 is movable into different locations such that the location and/or the orientation of the staple 70 can also be varied. In other examples, the alignment apparatus 40 can include adjustable components that permit the axially thickness of the base 48 and/or the width of the slot 51.

In certain examples, the alignment apparatus 40 can include accessories such as pen holder, paper cutter, measuring ruler, stapler remover, staple compartment, hole punch, tape dispenser, and the like.

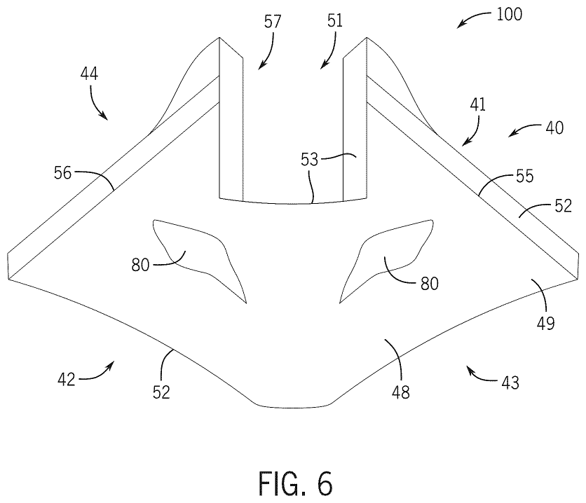

FIGS. 6-9D depict other example staple alignment systems 100, 200, 300, 400 thereof according to the present disclosure. The example staple alignment systems 100, 200, 300, 400 depicted in FIGS. 6-9D can include one or more features and/or components (e.g., indica, walls) described with reference to any of the other example staple alignment systems, such as the example staple alignment system 10 described above with respect to FIGS. 1-5. Similarly, the example staple alignment system 10 described with reference to FIGS. 1-5 can include any features and/or components described herein below with reference to any of the other example staple alignment systems 100, 200, 300, 400. Note that some components of the example staple alignment system 10 described with reference to FIGS. 6-9D that are similar to the components of the staple alignment system 10 described with reference to FIGS. 1-5 are similarly named and denoted with the same part numbers, however, it should be understood that the use of the same name and/or part numbers for features and/or components of the present disclosure should not be construed to indicate that the similarly marked systems and/or components are necessarily identical. Instead, the similarly marked systems and/or components may have varying features or characteristics. For instance, the base 25 depicted in FIG. 6 has a different shape and size than the base 25 depicted in FIG. 1 is different than the shape and the size of the base 25 depicted in FIG. 6.

FIG. 6 depicts an example alignment apparatus 40 of another example staple alignment system 100 according to the present disclosure. In this example, the alignment apparatus 40 includes one or more indentations 80 for assisting the operator with positioning the alignment apparatus 40 relative to the stapler 20.

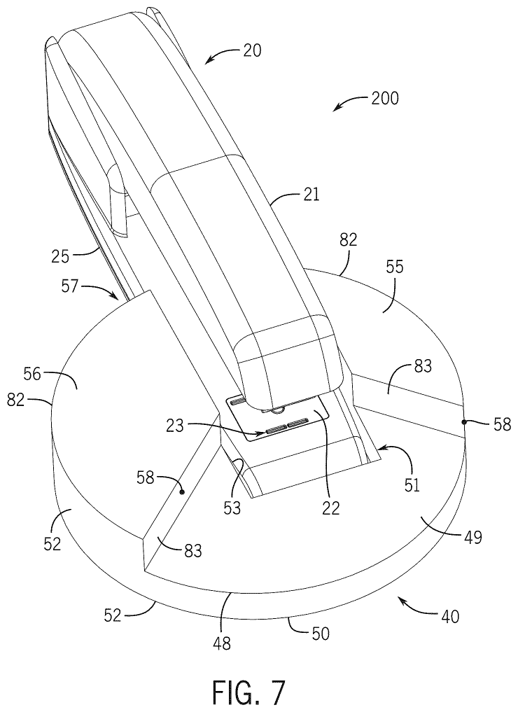

FIG. 7 depicts another example staple alignment system 200 according to the present disclosure. In this example, the alignment apparatus 40 the walls 55, 56 have curved surfaces 82 and a planar surfaces 83. The planar surfaces 83 face the paper 60 (not depicted).

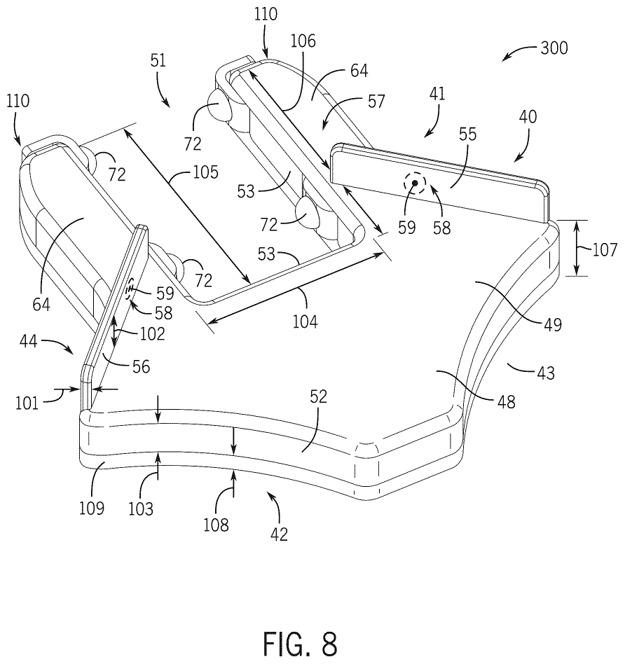

FIG. 8 depicts an example alignment apparatus 40 of another example staple alignment system 300 according to the present disclosure. In this example, the base 48 includes a pair of legs 64 that extend parallel to each other and further define the slot 51. Each leg 64 has a length 106 that extends between an end 110 of the leg 64 and one of the walls 55, 56. A plurality of coupling devices 72 are coupled to each leg 64, and in the example depicted in FIG. 8, two coupling devices 72 are coupled to each leg 64. The coupling devices 72 are for removably engaging the stapler 20 (see FIG. 1), and the coupling devices 72 extend into the slot 51. As noted above, the type of coupling devices 72 can vary. In the example depicted in FIG. 8, each coupling device 72 includes a rubber boss that extends into the slot 51. The rubber boss elastically compresses when engaging the stapler 20. In this example, the stapler 20 is compressed on either side by the coupling devices 72. In certain examples, the coupling device 72 is extendable from the slot surface 53 further into the slot 51 to thereby decrease or increase the width of the slot 51 at the locations of the coupling devices 72.

The example alignment apparatus 40 of FIG. 8 include walls 55, 56 each with a wall thickness 101 (e.g., 6.0 millimeters (mm)) and height 102 (e.g., 12.0 mm). The wall 55, 56 have height 107 (e.g., 23.5 mm). The base 48 has a thickness 103 (e.g., 3.0 mm, 10.0 mm). The slot 51 has a width 104 (e.g., 44.5 mm) and an overall length 105 (e.g., 52.0 mm). A length 106 is between the walls 55, 56 and the open end of the slot 51 (e.g., 26.0 mm).

The alignment apparatus 40 includes a pad 108 (e.g., the pad 108 comprises rubber) on the second base surface 50 of the base 48 that contacts the support surface and prevents sliding of the alignment apparatus 40 along the support surface. The pad thickness 109 is 3.5 mm.

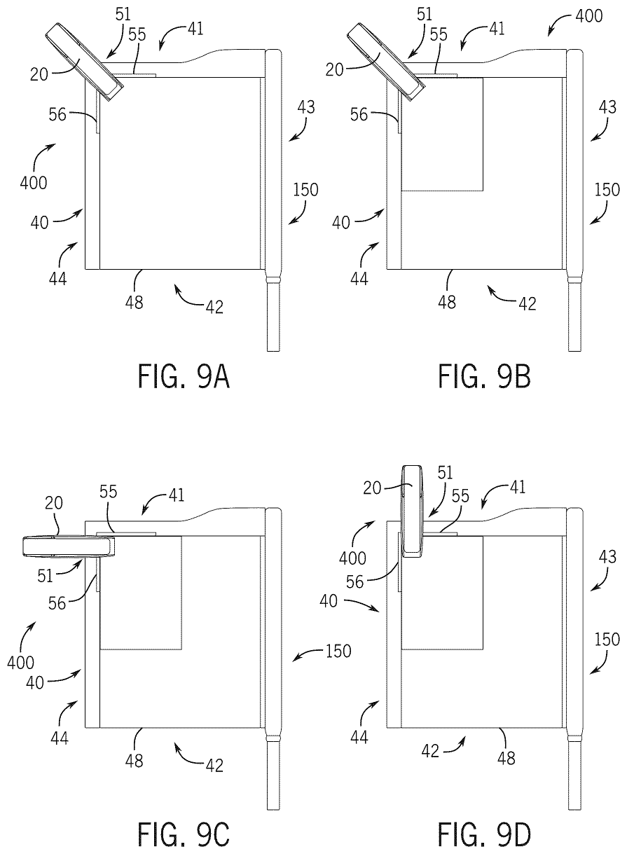

Referring now to FIGS. 9A-9D, another example staple alignment system 400 is depicted. The system 400 includes a stapler 20, an alignment apparatus 40, and a paper cutter blade mechanism 150. The paper cutter blade mechanism 150 is configured to be operable by the operator to slice paper as needed, and the paper cutter blade mechanism 150 is coupled to the base 48 of the alignment apparatus 40. FIG. 9A depicts the slot 51 and the stapler 20 at the upper lefthand corner of the base 48 and oriented at a 45.0 degree relative to the first end 41 and the second side 44. FIG. 9B depicts a piece of paper aligned with the stapler 20. FIG. 9C depicts the slot 51 along the second side 44, and FIG. 9D depicts the slot along the first end 41.

In certain examples, a staple alignment system includes a stapler configured to staple material together and an alignment apparatus including a base configured to axially support the material thereon and a first wall and a second wall axially extending from the base. The first wall and the second wall are configured to guide the material toward the stapler.

In independent aspects, the base defines a slot in which the stapler is received. In independent aspects, the base includes one or more slot surfaces that at least partially define the slot and a coupling device a coupling device that extends into the slot and couples to the stapler. In independent aspects, the coupling device is a rubber boss. In independent aspects, the base includes a pair of legs that extend parallel to each other and at least partially define the slot. In independent aspects, each leg in the pair of legs extends from an end to one of the walls. In independent aspects, the first wall and the second extend perpendicular to each other. In independent aspects, the first wall and the second wall are spaced apart from each other and define a void therebetween configured to receive the stapler. In independent aspects, a marker is coupled to the alignment apparatus such that the marker is aligned with the stapler and provides a visual cue corresponding to a location at which the stapler will staple the materials. In independent aspects, the marker is coupled to the first wall or the second wall. In independent aspects, the marker is a first marker and further including a second marker, and the first marker, the second marker, and the stapler are aligned with each other.

In certain examples, an alignment apparatus for coupling to a stapler that is configured to staple material together includes a base configured to axially support the material thereon and a first wall and a second wall coupled to and axially extending above the base. The first wall and the second wall are configured to guide the material toward the stapler as the material is received by the alignment apparatus.

In independent aspects, the base defines a slot in which the stapler is received. In independent aspects, the base includes one or more slot surfaces that at least partially define the slot and a coupling device extends into the slot and is configured to couple to the stapler. In independent aspects, the coupling device is a rubber boss. In independent aspects, the base includes a pair of legs that extend parallel to each other and at least partially define the slot. In independent aspects, the first wall and the second wall extend perpendicular to each other. In independent aspects, the first wall and the second wall are spaced apart from each other and define a void therebetween configured to receive the stapler. In independent aspects, a marker is coupled to the alignment apparatus such that the marker is aligned with the stapler and provides a visual cue corresponding to a location at which the stapler will staple the materials. In independent aspects, the marker is coupled to the first wall or the second wall.

In certain examples, staple alignment system includes a stapler configured to staple material together and an alignment apparatus that includes a base configured to axially support the material thereon, the base at least partially defines a slot in which the stapler is received, a first wall and a second wall axially extending from the base, the first wall and the second wall configured to guide the material toward the stapler, and a coupling device coupled to the base and extending into the slot, the coupling device couples to the stapler when the stapler is received into the slot to thereby retain the stapler in the slot.

In independent aspects, the base includes a first base surface on which the material is supported, and at least one slot surface which at least partially defines the slot and extends transverse to the first base surface. In independent aspects, the coupling device is coupled to the at least one slot surface. In independent aspects, the coupling device is a rubber boss. In independent aspects, the base includes a pair of legs that extend parallel to each other and along the slot. In independent aspects, each leg in the pair of legs extends from an end to one of the walls. In independent aspects, the first wall and the second extend perpendicular to each other. In independent aspects, the first wall and the second wall are spaced apart from each other and define a void therebetween configured to receive the stapler. In independent aspects, a marker is coupled to the alignment apparatus such that the marker is aligned with the stapler and provides a visual cue corresponding to location at which the stapler will staple the materials. In independent aspects, the marker is coupled to the first wall or the second wall. In independent aspects, the marker is a first marker and further comprising a second marker, and the first marker, the second marker, and the stapler are aligned with each other.

In certain examples, an alignment apparatus for coupling to a stapler that is configured to staple material together includes a base configured to axially support the material thereon, the base at least partially defines a slot configured to receive the stapler, a first wall and a second wall axially extending from the base, the first wall and the second wall configured to guide the material toward the slot, and a coupling device coupled to the base and extending into the slot, the coupling device configured to couple to the stapler when the stapler is received into the slot to thereby retain the stapler in the slot.

In independent aspects, the base includes a first base surface on which the material is supported, and at least one slot surface which at least partially defines the slot and extends transverse to the first base surface, and wherein the coupling device is coupled to the at least one slot surface. In independent aspects, the coupling device is a rubber boss. In independent aspects, the base includes a pair of legs that extend parallel to each other and along the slot. In independent aspects, the first wall and the second wall extend perpendicular to each other. In independent aspects, the first wall and the second wall are spaced apart from each other and define a void therebetween configured to receive the stapler. In independent aspects, a marker is coupled to the alignment apparatus such that the marker is aligned with the stapler and provides a visual cue corresponding to a location at which the stapler will staple the materials. In independent aspects, the marker is coupled to the first wall or the second wall.

In certain examples, an alignment apparatus for coupling to a stapler that is configured to staple material together includes a base configured to axially support the material thereon, the base includes a first base surface on which the material is supported, at least one slot surface which at least partially defines a slot, and a pair of legs that extend parallel to each other and along the slot, the at least one slot surface extends transverse to the first base surface, a first wall and a second wall axially extending from the base, the first wall and the second wall configured to guide the material toward the slot, the first wall and the second wall are spaced apart from each other and define a void therebetween configured to receive the stapler, and a coupling device coupled to the at least one slot surface and extending into the slot, the coupling device configured to couple to the stapler when the stapler is received into the slot to thereby retain the stapler in the slot.

Citations to a number of references are made herein. The cited references are incorporated by reference herein in their entireties. In the event that there is an inconsistency between a definition of a term in the specification as compared to a definition of the term in a cited reference, the term should be interpreted based on the definition in the specification.

In the present description, certain terms have been used for brevity, clarity, and understanding. No unnecessary limitations are to be inferred therefrom beyond the requirement of the prior art because such terms are used for descriptive purposes and are intended to be broadly construed. The different apparatuses, systems, and method steps described herein may be used alone or in combination with other apparatuses, systems, and methods. It is to be expected that various equivalents, alternatives, and modifications are possible within the scope of the appended claims.

This written description uses examples to disclose the invention and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A staple alignment system comprising:
a stapler configured to staple material together; and
an alignment apparatus includes:
a base configured to axially support the material thereon, the base at least partially defines a slot in which the stapler is received;
a first wall and a second wall axially extending from the base, the first wall and the second wall configured to guide the material toward the stapler; and
a coupling device coupled to the base and extending into the slot, the coupling device couples to the stapler when the stapler is received into the slot to thereby retain the stapler in the slot.

2. The staple alignment system according to claim 1, wherein the base includes a first base surface on which the material is supported, and at least one slot surface which at least partially defines the slot and extends transverse to the first base surface.

3. The staple alignment system according to claim 2, wherein the coupling device is coupled to the at least one slot surface.

4. The staple alignment system according to claim 3, wherein the coupling device is a rubber boss.

5. The staple alignment system according to claim 2, wherein the base includes a pair of legs that extend parallel to each other and along the slot.

6. The staple alignment system according to claim 5, wherein each leg in the pair of legs extends from an end to one of the walls.

7. The staple alignment system according to claim 1, wherein the first wall and the second extend perpendicular to each other.

8. The staple alignment system according to claim 1, wherein the first wall and the second wall are spaced apart from each other and define a void therebetween configured to receive the stapler.

9. The staple alignment system according to claim 1, wherein the alignment apparatus includes a marker coupled to the alignment apparatus such that the marker is aligned with the stapler and provides a visual cue corresponding to location at which the stapler will staple the materials.

10. The staple alignment system according to claim 9, wherein the marker is coupled to the first wall or the second wall.

11. The staple alignment system according to claim 9, wherein the marker is a first marker and further comprising a second marker, and wherein the first marker, the second marker, and the stapler are aligned with each other.

12. An alignment apparatus for coupling to a stapler that is configured to staple material together, the alignment apparatus comprising:
a base configured to axially support the material thereon, the base at least partially defines a slot configured to receive the stapler;
a first wall and a second wall axially extending from the base, the first wall and the second wall configured to guide the material toward the slot; and
a coupling device coupled to the base and extending into the slot, the coupling device configured to couple to the stapler when the stapler is received into the slot to thereby retain the stapler in the slot.

13. The alignment apparatus according to claim 12, wherein the base includes a first base surface on which the material is supported, and at least one slot surface which at least partially defines the slot and extends transverse to the first base surface, and wherein the coupling device is coupled to the at least one slot surface.

14. The alignment apparatus according to claim 13, wherein the coupling device is a rubber boss.

15. The alignment apparatus according to claim 12, wherein the base includes a pair of legs that extend parallel to each other and along the slot.

16. The alignment apparatus according to claim 12, wherein the first wall and the second wall extend perpendicular to each other.

17. The alignment apparatus according to claim 12, wherein the first wall and the second wall are spaced apart from each other and define a void therebetween configured to receive the stapler.

18. The alignment apparatus according to claim 12, further comprising a marker coupled to the alignment apparatus such that the marker is aligned with the stapler and provides a visual cue corresponding to a location at which the stapler will staple the materials.

19. The alignment apparatus according to claim 18, wherein the marker is coupled to the first wall or the second wall.

20. An alignment apparatus for coupling to a stapler that is configured to staple material together, the alignment apparatus comprising:
a base configured to axially support the material thereon, the base includes a first base surface on which the material is supported, at least one slot surface which at least partially defines a slot, and a pair of legs that extend parallel to each other and along the slot, the at least one slot surface extends transverse to the first base surface;
a first wall and a second wall axially extending from the base, the first wall and the second wall configured to guide the material toward the slot, the first wall and the second wall are spaced apart from each other and define a void therebetween configured to receive the stapler; and
a coupling device coupled to the at least one slot surface and extending into the slot, the coupling device configured to couple to the stapler when the stapler is received into the slot to thereby retain the stapler in the slot.
